(19) United States
(12) Patent Application Publication
(10) Pub. No.: US 2019/0048878 A1
(43) Pub. Date: Feb. 14, 2019

(54) COMPRESSOR IMPELLER AND TURBOCHARGER

(71) Applicant: KABUSHIKI KAISHA TOYOTA JIDOSHOKKI, Kariya-shi, Aichi-ken (JP)

(72) Inventor: Kenta AKIMOTO, Kariya-shi (JP)

(73) Assignee: KABUSHIKI KAISHA TOYOTA JIDOSHOKKI, Kariya-shi, Aichi-ken (JP)

(21) Appl. No.: 16/076,745

(22) PCT Filed: Feb. 9, 2017
(86) PCT No.: PCT/JP2017/004772

§ 371 Date: Aug. 9, 2018

(30) Foreign Application Priority Data
Feb. 22, 2016 (JP) 2016-030771

(51) Int. Cl. F04D 17/12; F02B 33/40; F04D 29/66

(52) U.S. Cl. CPC F04D 17/122; F04D 29/661; F02B 33/40

(57) ABSTRACT

A centrifugal compressor impeller is configured such that the compressor impeller is accommodated within a housing and is rotated in a predetermined rotational direction relative to the housing to compress fluid which flows in the axial direction and deliver the fluid to the outside in the radial direction. The compressor impeller is provided with: a hub extending in the axial direction; and a plurality of blades extending from the hub toward the outside in the radial direction and arranged side by side in the rotational direction. At least one of the plurality of blades is provided with a corner formed by both a leading edge extending from the hub toward the outside in the radial direction, and a shroud line connected to the leading edge. The corner has a through-section extending between the front and rear sides of the blade.

### TECHNICAL FIELD

The present invention relates to a centrifugal compressor impeller that receives fluid flowing in an axial direction, compresses the fluid, and discharges the compressed fluid outward in a radial direction, and a turbocharger that includes the compressor impeller.

### BACKGOUND ART

Exhaust energy is emitted from an engine of a vehicle or the like. A turbocharger or the like uses the exhaust energy to perform supercharging. The turbocharger may include a centrifugal compressor impeller that receives fluid flowing in an axial direction, compresses the fluid, and discharges the compressed fluid outward in a radial direction. When the amount of fluid flowing into such a compressor impeller decreases, surging may occur. When surging occurs, the compressor impeller will not compress the fluid even when the compressor impeller rotates.

Conventionally, a circulation structure referred to as a casing treatment is arranged in a housing accommodating the compressor impeller to restrict the occurrence of surging. For example, as described in patent document 1, this structure includes a circulation passage in the housing to return some of the fluid around the compressor impeller to an intake passage. Thus, the virtual amount of the fluid flowing into the compressor impeller is increased. This reduces the occurrence of surging.

### PRIOR ART LITERATURE

### Patent Literature

Patent Document 1: Japanese Laid-Open Patent Publication No. 2005-23792.

### SUMMARY OF THE INVENTION

### Problem to be Solved by the Invention

However, a curved intake pipe may be connected to the intake passage of the compressor impeller. Thus, the pressure of the fluid drawn by the compressor impeller may be biased in a rotational direction (circumferential direction) of the compressor impeller. This produces a pressure difference in the circumferential direction inside the circulation passage, which is arranged around the compressor impeller, and causes the fluid to flow in the circumferential direction in the circulation passage. Thus, the axial flow in the circulation passage returning the fluid to the intake passage is impeded. As a result, the casing treatment effect for reducing surging cannot be fully implemented.

It is an object of the present invention to provide a compressor impeller and a turbocharger that reduce the occurrence of surging more effectively than the prior art.

### Means for Solving the Problem

A centrifugal compressor impeller that solves the above problem is configured to be accommodated in a housing and rotate relative to the housing in a predetermined rotation direction to compress a fluid flowing in an axial direction and send out the fluid in a radial direction. The compressor impeller includes a hub that extends in the axial direction. Further, the compressor impeller includes a plurality of vanes that extend outward in the radial direction from the hub and are arranged next to one another in the rotation direction. At least one of the vanes includes a corner portion defined by a leading edge, which extends outward in the radial direction from the hub at an upstream end with respect to a flow direction of the fluid, and a shroud line, which is connected to the leading edge and extends along an inner wall of the housing. The corner portion includes a through portion that extends through the vane from a front side to a back side.

A turbocharger that solves the above problem includes the above compressor impeller.

### BRIEF DESCRIPTION OF THE DRAWINGS

FIG. 1 is a schematic cross-sectional view of a turbocharger in accordance with one embodiment.

FIG. 2 is a perspective view of a compressor impeller in the turbocharger shown in FIG. 1.

FIG. 3 is a schematic diagram of a slit as viewed in direction III in FIG. 2.

FIG. 4 is a cross-sectional view taken along line IV-IV in FIG. 3.

FIGS. 5A and 5B are schematic diagrams showing modified examples of the slit.

FIGS. 6A and 6B are schematic diagrams showing modified examples of the slit.

FIGS. 7A and 7B are schematic diagrams showing modified examples of the slit.

### EMBODIMENT OF THE INVENTION

A turbocharger that includes a compressor impeller in accordance with one embodiment of the present invention will now be described with reference to the drawings. The compressor impeller may be applied not only to a turbocharger but also to another type of a centrifugal compressor.

### Schematic Structure of the Turbocharger

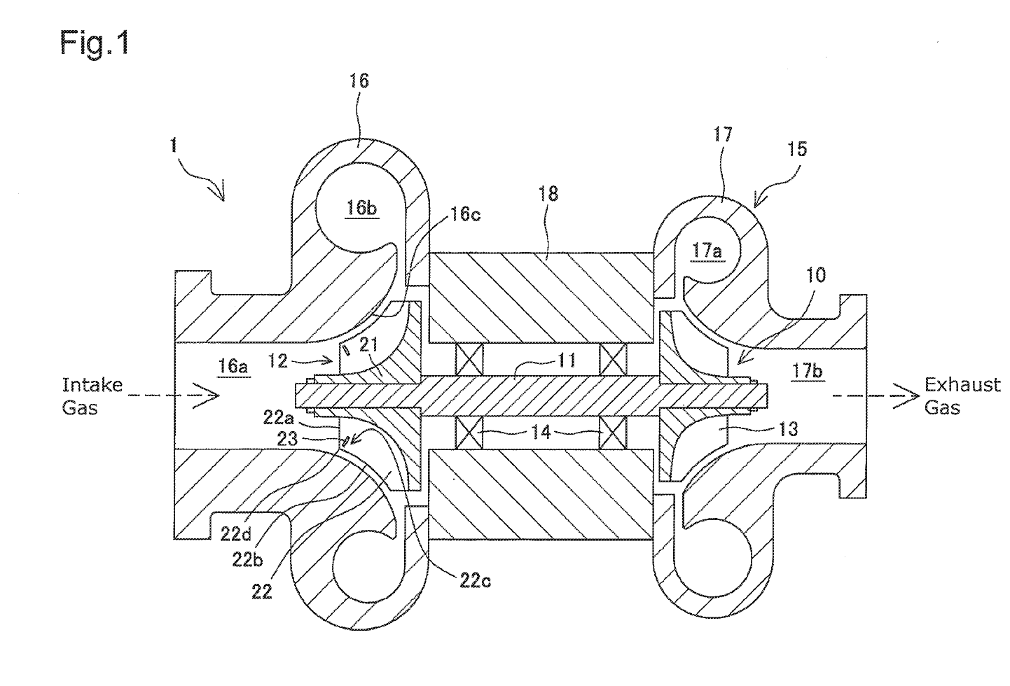

The turbocharger 1 shown in FIG. 1 is arranged in an engine of a vehicle or the like (not shown) and uses exhaust energy from the engine to perform supercharging. The turbocharger 1 includes a rotating body 10. The rotating body includes a rotation shaft 11, a compressor impeller 12, and a turbine impeller 13. Further, the turbocharger 1 includes a housing 15 accommodating the rotating body 10.

The compressor impeller 12 is coupled to one end (left end as viewed in FIG. 1) of the rotation shaft 11, and the turbine impeller 13 is coupled to the other end (right end as viewed in FIG. 1) of the rotation shaft 11. The rotation shaft 11 is rotationally supported by bearings 14. Thus, the rotating body 10 is rotatable relative to the housing 15. The bearings 14 are schematically shown in FIG. 1. The bearings 14 may include radial bearings receiving load acting in a radial direction and thrust bearings receiving load acting in a thrust direction.

The housing 15 includes a compressor housing portion 16 accommodating the compressor impeller 12, a turbine housing portion 17 accommodating the turbine impeller 13, and a tubular bearing housing portion 18 accommodating the bearings 14. The bearing housing portion 18 is located in the axially middle part of the housing 15. The compressor housing portion 16 is coupled to one end (left end as viewed in FIG. 1) of the bearing housing portion 18, and the turbine housing portion 17 is coupled to the other end (right end as viewed in FIG. 1) of the bearing housing portion 18.

The compressor housing portion 16 includes a tubular intake passage 16a and a volute scroll passage 16b. The intake passage 16a is located outward from the compressor impeller 12 in the axial direction to supply the intake gas to the compressor impeller 12. The scroll passage 16b is located outward from the compressor impeller 12 in the radial direction to discharge the intake gas compressed by the compressor impeller 12. Further, the turbine housing portion 17 includes a volute scroll passage 17a and a tubular exhaust passage 17b. The scroll passage 17a is located outward from the turbine impeller 13 in the radial direction to supply the exhaust gas to the turbine impeller 13. The exhaust passage 17b is located outward from the turbine impeller 13 in the axial direction to discharge the exhaust gas that has been used to drive the turbine impeller 13.

In the turbocharger 1, the exhaust gas supplied from the scroll passage 17a rotates the turbine impeller 13, which, in turn, rotates the compressor impeller 12. Thus, the intake gas is drawn into the compressor impeller 12 from the intake passage 16a and compressed by the rotation of the compressor impeller 12. The intake gas compressed by the compressor impeller 12 is discharged outward in the radial direction toward the scroll passage 16b and consequently supplied to the engine.

### Detailed Structure of the Compressor Impeller

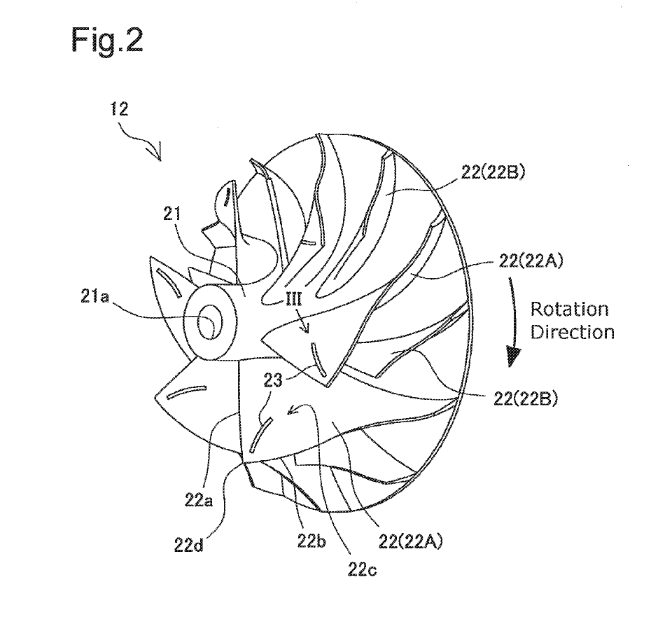

As shown in FIG. 2, the compressor impeller 12 is a centrifugal compressor impeller that includes a hub 21 extending in the axial direction and a plurality of vanes 22 extending outward in the radial direction from the hub 21. The radially central portion of the hub 21 includes a through hole 21a extending in the axial direction. The rotation shaft 11 is inserted in the through hole 21a. The vanes 22 include long blades 22A and short blades 22B that are alternately arranged next to one another in the rotation direction. Further, each long blade 22A includes a slit 23 that extends through the long blade 22A in the thickness direction from the front side to the back side of the long blade 22A.

As shown in FIGS. 1 and 2, each vane 22 (specifically, long blade 22A) includes a corner portion 22c defined by a leading edge 22a and a shroud line 22b. The corner portion 22c includes the slit 23. The leading edge 22a is part of the contour of the vane 22 at the upstream end with respect to the flow direction of the intake gas. Further, the leading edge 22a is a straight portion extending outward in the radial direction from the hub 21. The shroud line 22b is part of the contour of the vane 22 opposing an inner wall 16c (refer to FIG. 1) of the compressor housing portion 16. Further, the shroud line 22b is a curved portion extending along the inner wall 16c. The shroud line 22b is connected to the leading edge 22a at a corner 22d (intersection). The corner portion 22c is a region (angular region) in a predetermined range that includes the corner 22d, which is the intersection of the leading edge 22a and the shroud line 22b.

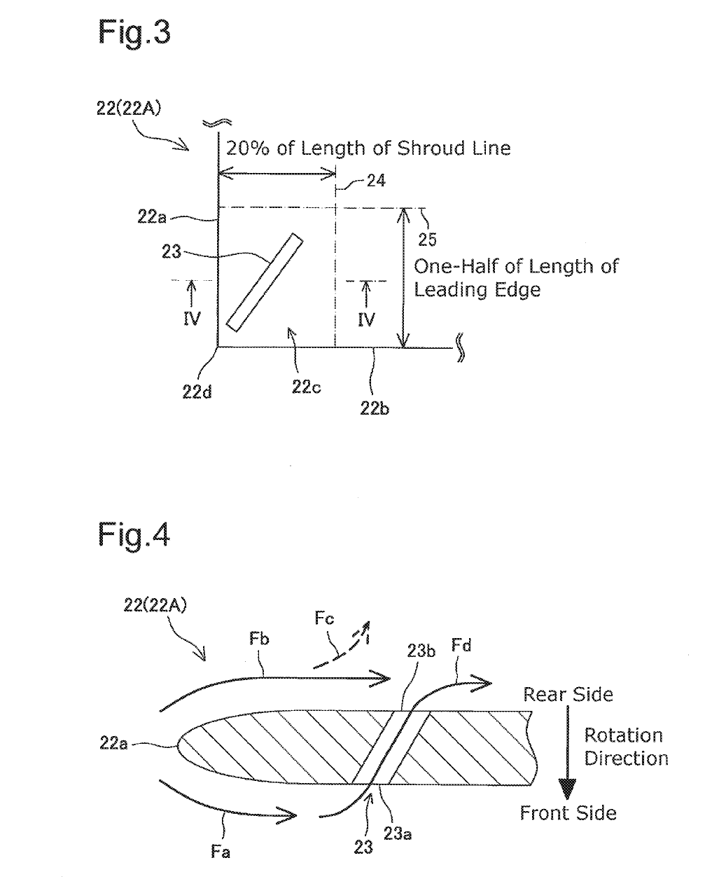

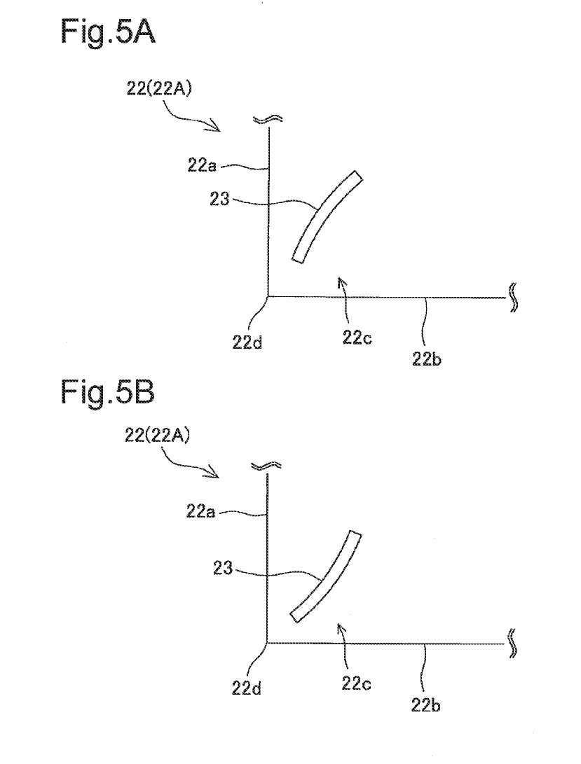

FIG. 3 is a schematic diagram of the slit 23 as viewed in direction III in FIG. 2, that is, the slit 23 as viewed from a trailing side with respect to the rotation direction of the compressor impeller 12. For the sake of convenience, in FIG. 3, the leading edge 22a and the shroud line 22b intersect at a right angle. However, the leading edge 22a and the shroud line 22b do not have to intersect at a right angle. The same applies to FIGS. 5A to 7B.

As shown in FIG. 3, the slit 23 in the present embodiment extends from the proximity of the corner 22d, which is the intersection of the leading edge 22a and the shroud line 22b. The slit 23 extends straight and obliquely relative to each of the leading edge 22a and the shroud line 22b. Further, the slit 23 is formed in a region surrounded by the leading edge 22a, the shroud line 22b, a first hypothetical line 24, and a second hypothetical line 25. The first hypothetical line 24 is separated from the leading edge 22a by twenty percent of the length of the shroud line 22b. The second hypothetical line 25 is separated from the shroud line 22b by one-half the length of the leading edge 22a. The slit 23 includes one end (left lower end viewed in FIG. 3) that does not reach the leading edge 22a or the shroud line 22b. Further, the slit 23 is an elongated hole entirely surrounded by the material forming the vane 22. In other words, the slit 23 (through portion) is located inward from the periphery of the vane 22.

FIG. 4 is a cross-sectional view taken along line IV-IV in FIG. 3. In the description hereafter, the trailing side with respect to the rotation direction of the compressor impeller 12 will be referred to as the rear side, and the leading side will be referred to as the front side. The vane 22 includes a front surface that is directed in the rotation direction and a rear surface that is located at the opposite side of the front surface. The slit 23 includes a front opening 23a that opens in the front surface of the vane 22 and a rear opening 23b that opens in the rear surface of the vane 22. FIG. 4 shows a cross section of the vane 22 taken along a front-rear direction (thickness direction). As shown in FIG. 4, the slit 23 extends diagonally relative to the front-rear direction (thickness direction) of the vane 22 so that the rear opening 23b is farther from the leading edge 22a than the front opening 23a.

### Principle of Speed Loss Occurrence and Measure Against Speed Loss

As shown in FIG. 4, the intake gas drawn into the compressor impeller 12 is divided at the leading edge 22a of the vane 22 into a flow Fa at the front side and a flow Fb at the rear side. During rotation of the compressor impeller 12, the rear flow Fb relatively moves away from the vane 22. When the amount of the intake gas is small, the attack angle of the intake gas at the vane 22 becomes relatively large. Thus, as indicated by arrow Fc, the intake gas is separated from the rear surface of the vane 22 and does not flow along the vane 22. This is referred to as a speed-loss effect.

Accordingly, in the present embodiment, the slit 23 is arranged in the vane 22 so that some of the intake gas flowing at the front side flows through the slit 23 toward the rear side as indicated by arrow Fd in FIG. 4. In this manner, the intake gas supplied to the rear side through the slit 23 increases the amount of the intake gas flowing at the rear side. This reduces the separation and speed loss of the intake gas at the rear side.

The separation and speed loss of the intake gas occurs more easily at portions of the vane 22 located further upstream in the flow direction of the intake gas. Further, the separation and speed loss of the intake gas occurs more easily at portions where the circumferential speed is high, that is, the portions of the vane 22 located further outward in the radial direction. The upstream portions in the flow direction of the intake gas correspond to portions of the vane 22 in the proximity of the leading edge 22a. Further, the portions where the circumferential speed is high (outward portions in radial direction) correspond to portions of the vane 22 in the proximity of the shroud line 22b. Accordingly, the corner portion 22c, which is defined by the leading edge 22a and the shroud line 22b, meets the two conditions described above. Thus, the slit 23 arranged in such a portion reduces the separation and speed loss of the intake gas more effectively.

### Effect

At least one of the vanes 22 (specifically, long blade 22A) includes the corner portion 22c, which is defined by the leading edge 22a and the shroud line 22b. The corner portion 22c includes the slit 23 (through portion), which extends through the vane 22 from the front side to the back side. As described above, the corner portion 22c is where the conditions easily causing the separation and speed loss of the intake gas are met. Thus, the slit 23 arranged in such a portion effectively reduces the separation and speed loss of fluid. As a result, occurrence of surging can be reduced more effectively than the prior art. Further, the arrangement of the slit 23 in the corner portion 22c allows the compressor impeller 12 to improve the compression effect of each vane 22. Hence, even when the pressure of the intake gas is biased in the circumferential direction in the intake passage 16a, the intake gas is adequately compressed and thus more advantageous than the conventional casing treatment. Additionally, there is no need to include a circulation passage in the compressor housing portion 16 like a casing treatment. This increases freedom of design for the compressor housing portion 16 and is thus advantageous.

The slit 23 extends diagonally relative to the thickness direction of the vane 22 so that the rear opening 23b located at the trailing side with respect to the rotation direction is farther from the leading edge 22a than the front opening 23a located at the leading side with respect to the rotation direction. Accordingly, as indicated by arrow Fd in FIG. 4, the intake gas flowing out from the slit 23 toward the rear side easily flows continuingly along the rear surface of the vane 22. This reduces the separation and speed loss of the intake gas at the rear side further effectively.

The slit 23 is formed in the region between the shroud line 22b and a location separated from the shroud line 22b by one-half the length of the leading edge 22a (second hypothetical line 25). Accordingly, the slit 23 is located further proximate to the shroud line 22b, that is, in a portion where the circumferential speed is higher and the separation and speed loss of the intake gas occurs more easily. This reduces the separation and speed loss of the intake gas more effectively.

The slit 23 is formed in the region between the leading edge 22a and a location separated from the leading edge 22a by twenty percent of the length of the shroud line 22b (first hypothetical line 24). Accordingly, the slit 23 is located further proximate to the leading edge 22a, that is, a portion located further upstream in the flow direction of the intake gas and where the separation and speed loss of the intake gas occurs more easily. This reduces the separation and speed loss of the intake gas more effectively.

The corner portion 22c includes the slit 23 that serves as “the through portion” and extends along the surface of the vane 22. The elongated slit 23 serving as the through portion allows the amount of intake gas flowing through the slit 23 from the front side toward the rear side to increase. This further ensures reduction of the separation and speed loss of the intake gas.

The slit 23 extends from the proximity of the corner 22d, which is the intersection of the leading edge 22a and the shroud line 22b, and extends obliquely relative to each of the leading edge 22a and the shroud line 22b. As described above, the separation and speed loss of the intake gas occurs more easily at portions located further upstream in the flow direction of the intake gas. Further, the separation and speed loss of the intake gas occurs more easily at the portions where the circumferential speed is high (outward portions in radial direction). It is considered that the portion where the separation and speed loss of the intake gas occurs easily extends in a substantially oblique direction from the proximity of the corner 22d. Thus, by extending the slit 23 in such a direction, the separation and speed loss of the intake gas can be effectively reduced.

The slit 23 is entirely surrounded by the material forming the vane 22. This improves the strength of the vane 22 around the slit 23, and the vane 22 does not tear from the slit 23 during rotation of the compressor impeller 12.

### Other Embodiments

The present invention is not limited to the above embodiment, and the elements in the embodiment may be combined or changed within the scope of the claims.

For example, in the above embodiment, the slit 23 extends straight and obliquely relative to each of the leading edge 22a and the shroud line 22b from the proximity of the corner 22d, which is the intersection of the leading edge 22a and the shroud line 22b. However, the slit 23 does not have to extend straight. As shown in FIGS. 5A and 5B, the slit 23 may extend along a curved line of which the distance from the leading edge 22a and the distance from the shroud line 22b increase as the corner 22d becomes farther.

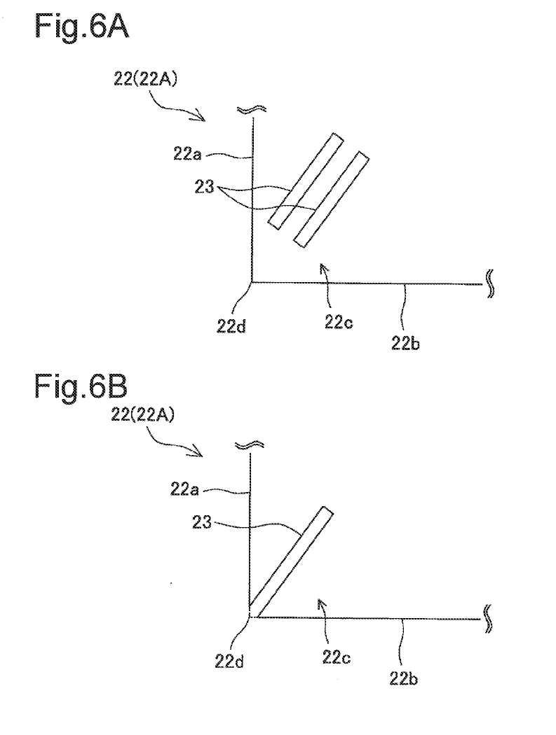

In the above embodiment, each vane 22 includes only one slit 23. However, each vane 22 may include a plurality of the slits 23. In this case, for example, as shown in FIG. 6A, the plurality of (two in this case) slits 23 can be arranged parallel to each other in each vane 22. Nevertheless, the slits 23 do not have to be parallel to each other. For example, the inclination angles of the slits 23 relative to the leading edge 22a (or shroud line 22b) may differ from each other within the extent that the slits 23 do not intersect, or do intersect.

In the above embodiment, the slit 23 extends from the proximity of the corner 22d. However, as shown in FIG. 6B, the slit 23 may extend from the corner 22d. That is, the through portion may be connected to the outer edge (leading edge 22a or shroud line 22b) of the vane 22. In this case, the slit 23 is not entirely surrounded by the material forming the vane 22, and the slit 23 is a cutout that partially opens in the outer edge of the vane 22. As long as the strength of the vane 22 is maintained, the slit 23 may be such a cutout.

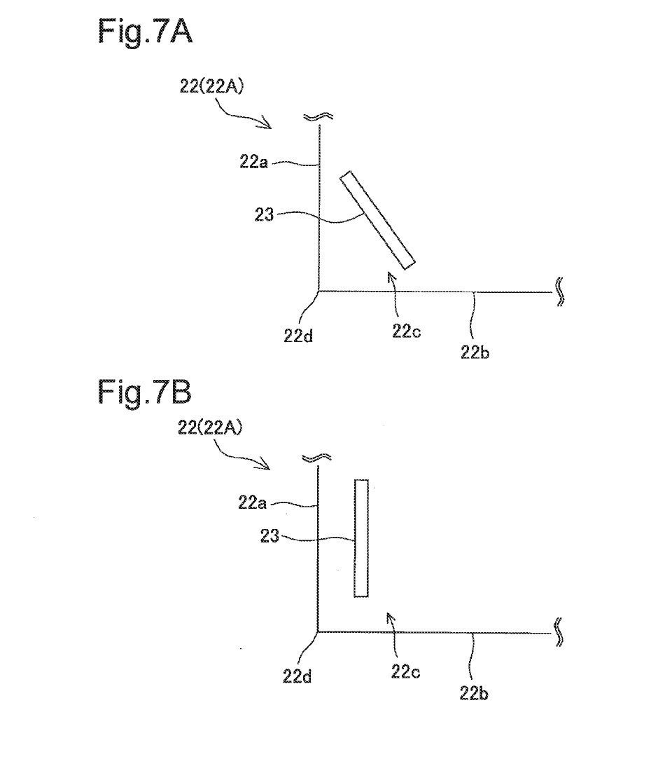

In the above embodiment, the slit 23 extends obliquely relative to each of the leading edge 22a and the shroud line 22b. However, the extending direction of the slit 23 is not limited to such a direction. For example, as shown in FIG. 7A, the slit 23 does not have to extend at the corner 22d or the proximity of the corner 22d. Further, as shown in FIG. 7B, the slit 23 may be parallel to the leading edge 22a. Alternatively, the slit 23 may be parallel to the shroud line 22b.

In the above embodiment, the corner portion 22c includes the slit 23, which serves as “the through portion” and extends along the surface of the vane 22. However, the shape of the through portion is not specifically limited to the elongated slit 23 and can be, for example, a round through hole or the like.

In the above embodiment, among the long blades 22A and the short blades 22B of the vanes 22, the slit 23 is arranged in each long blade 22A. However, the vanes 22 that include the slit 23 can be changed when required. For example, the slit 23 may be arranged in every one of the vanes 22 including the short blades 22B. Further, the slit 23 may be alternately arranged in the long blades 22A in the rotation direction. Alternatively, only at least one of the vanes 22 may include the slit 23 (through portion).

1. A centrifugal compressor impeller that is configured to be accommodated in a housing and rotate relative to the housing in a predetermined rotation direction to compress a fluid flowing in an axial direction and send out the fluid outward in a radial direction, the compressor impeller comprising:
a hub that extends in the axial direction; and
a plurality of vanes that extend outward in the radial direction from the hub and are arranged next to one another in the rotation direction, wherein
at least one of the vanes includes a corner portion defined by a leading edge, which extends outward in the radial direction from the hub at an upstream end with respect to a flow direction of the fluid, and a shroud line, which is connected to the leading edge and extends along an inner wall of the housing,
and the corner portion includes a through portion that extends through the vane from a front side to a back side.

2. The compressor impeller according to claim 1, wherein the vane includes a front surface that is directed in the rotation direction and a rear surface that is located at an opposite side of the front surface;
the through portion includes a front opening that opens in the front surface and a rear opening that opens in the rear surface; and
the through portion extends diagonally relative to a thickness direction of the vane so that the rear opening is farther from the leading edge than the front opening.

3. The compressor impeller according to claim 1, wherein the through portion is formed in a region between the shroud line and a location separated from the shroud line by one-half of a length of the leading edge.

4. The compressor impeller according to claim 1, wherein the through portion is formed in a region between the leading edge and a location separated from the leading edge by twenty percent of a length of the shroud line.

5. The compressor impeller according to claim 1, wherein the through portion is a slit that extends along the surface of the vane.

6. The compressor impeller according to claim 5, wherein the slit extends obliquely relative to each of the leading edge and the shroud line from an intersection of the leading edge and the shroud line or from a location proximate to the intersection.

7. The compressor impeller according to claim 5, wherein the slit is entirely surrounded by a material forming the vane.

8. A turbocharger comprising the compressor impeller according to claim 1.
